(19) United States
(12) Patent Application Publication
(10) Pub. No.: US 2025/0140041 A1
(43) Pub. Date: May 1, 2025

(54) DRIVE RECORDER DEVICE, VIDEO RECORDING METHOD, AND NON-TRANSITORY RECORDING MEDIUM

(71) Applicant: TOYOTA JIDOSHA KABUSHIKI KAISHA, Aichi-ken (JP)

(72) Inventor: Oki SHIMIZU, Toyota-shi (JP)

(21) Appl. No.: 18/918,063

(22) Filed: Oct. 17, 2024

(30) Foreign Application Priority Data
Oct. 27, 2023 (JP) 2023-184539

(51) Int. Cl. G07C 5/08; G01P 15/00; G06N 20/00

(52) U.S. Cl. CPC G07C 5/0866; G01P 15/00; G06N 20/00

(57) ABSTRACT

A drive recorder device starts video recording when an impact of a predetermined acceleration threshold value or more is detected by an acceleration sensor at the time of an ignition power supply of a vehicle being turned off, determines whether a door of the vehicle changes from an open state to a closed state, and learns the acceleration threshold value using the impact detected by the acceleration sensor during a learning period between a first time point at which the door changes from the open state to the closed state and a second time point which is a predetermined time before the first time point when the door changes from the open state to the closed state.

### FIELD

The present disclosure relates to drive recorder device, video recording method, and non-transitory recording medium.

### BACKGROUND

PTL 1 (Japanese Unexamined Patent Publication No. 2023-75765) describes a technique for starting shooting video with a camera and recording the video shot by the camera when vibration is detected by an acceleration sensor and stopping recording the video when door open/close signal of a vehicle is detected before a predetermined time elapses from a time point when the vibration is detected by the acceleration sensor.

As in the technique described in PTL 1, if it is determined whether a door of the vehicle changes from an open state to a closed state or an accident occurs only by timing of an impact detected by the acceleration sensor, there is a possibility that the video cannot be recorded when the timing of the door of the vehicle changing from the open state to the closed state and the timing of accident occurrence are the same.

It is not easy to appropriately set the acceleration threshold value which is used for determining whether the door of the vehicle changes from the open state to the closed state or the accident occurs because the appropriate acceleration threshold value depends on the vehicle and mounting position of the acceleration sensor.

### SUMMARY

In view of the above-mentioned points, it is an object of the present disclosure to provide drive recorder device, video recording method, and non-transitory recording medium that can make an acceleration threshold value used for determining whether to start video recording when the ignition power supply of a vehicle is turned off to be an appropriate value.

(1) One aspect of the present disclosure is a drive recorder device including a processor configured to: start video recording when an impact of a predetermined acceleration threshold value or more is detected by an acceleration sensor at the time of an ignition power supply of a vehicle being turned off; determine whether a door of the vehicle changes from an open state to a closed state; and learn the acceleration threshold value using the impact detected by the acceleration sensor during a learning period between a first time point at which the door changes from the open state to the closed state and a second time point which is a predetermined time before the first time point when the door changes from the open state to the closed state.

(2) In the drive recorder device of the aspect (1), the processor may be configured to learn the acceleration threshold value so that the acceleration threshold value is greater than the impact detected by the acceleration sensor when the door changes from the open state to the closed state, and less than or equal to the impact detected by the acceleration sensor when an accident occurs.

(3) In the drive recorder device of the aspect (1), the processor may not be configured to use the impact associated with occurrence of the accident among the impact detected by the acceleration sensor during the learning period to learn the acceleration threshold value.

(4) Another aspect of the present disclosure is a video recording method including: starting video recording when an impact of a predetermined acceleration threshold value or more is detected by an acceleration sensor at the time of an ignition power supply of a vehicle being turned off; determining whether a door of the vehicle changes from an open state to a closed state; and learning the acceleration threshold value using the impact detected by the acceleration sensor during a learning period between a first time point at which the door changes from the open state to the closed state and a second time point which is a predetermined time before the first time point when the door changes from the open state to the closed state.

(5) Another aspect of the present disclosure is a non-transitory recording medium having recorded thereon a computer program for causing a processor to execute a processing including: starting video recording when an impact of a predetermined acceleration threshold value or more is detected by an acceleration sensor at the time of an ignition power supply of a vehicle being turned off; determining whether a door of the vehicle changes from an open state to a closed state; and learning the acceleration threshold value using the impact detected by the acceleration sensor during a learning period between a first time point at which the door changes from the open state to the closed state and a second time point which is a predetermined time before the first time point when the door changes from the open state to the closed state.

According to the present disclosure, it is possible to set an acceleration threshold value used for determining whether to start video recording when the ignition power supply of a vehicle is turned off to an appropriate value.

### BRIEF DESCRIPTION OF DRAWINGS

FIG. 1 is a view showing an example of a vehicle 1 to which a drive recorder device 16 of a first embodiment is applied.

FIG. 2 is a flowchart for explaining an example of processing performed by a processor 163 of the drive recorder device 16 of the first embodiment.

### DESCRIPTION OF EMBODIMENTS

Below, referring to the drawings, embodiments of drive recorder device, video recording method, and non-transitory recording medium of the present disclosure will be explained.

### First Embodiment

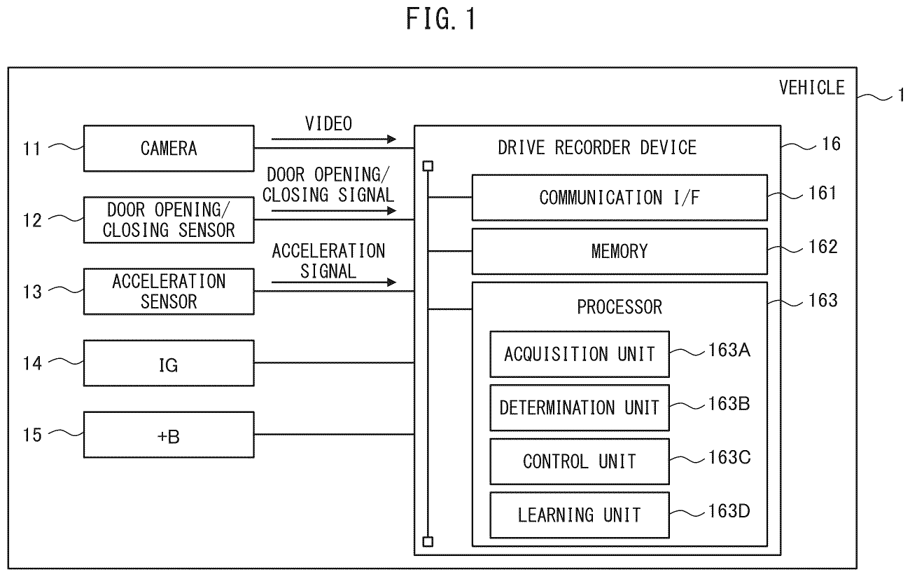

FIG. 1 is a view showing an example of a vehicle 1 to which a drive recorder device 16 of a first embodiment is applied.

In the example shown in FIG. 1, the vehicle 1 includes camera 11, door opening/closing sensor 12, acceleration sensor 13, ignition power supply 14, permanent power supply 15, and drive recorder device 16.

In the example shown in FIG. 1, the vehicle 1 is provided with the camera 11 as a surrounding situation sensor and is provided with the door opening/closing sensor 12 and the acceleration sensor 13 as a vehicle condition sensor. In another example, the vehicle 1 may be provided with the surrounding situation sensor other than the camera 11 (for example, a LiDAR (Laser Imaging Detection and Ranging), a radar, a sonar, or the like), or may be provided with the vehicle condition sensor other than the door opening/closing sensor 12 and the acceleration sensor 13 (for example, a yaw rate sensor, or the like).

In the example shown in FIG. 1, the camera 11 is disposed on, for example, a windshield, a rear glass, or the like of the vehicle 1, and shoots front, rear, side, inside, or the like of the vehicle 1, and transmits video of front, rear, side, inside, or the like of the vehicle 1 to the drive recorder device 16. Specifically, the camera 11 has the function of not only shooting and transmitting the video to the drive recorder device 16 when the ignition power supply 14 is turned on, but also shooting and transmitting the video to the drive recorder device 16 when the ignition power supply 14 is turned off (when the vehicle 1 is parked).

In another example, position (location) of the camera 11 may be different from the example shown in FIG. 1, or a shooting target of the camera 11 may be different from the example shown in FIG. 1.

In the example shown in FIG. 1, the door opening/closing sensor 12 detects open/closed state of the door (not shown) of the vehicle 1 and transmits a signal (door opening/closing signal) indicating the open/closed state of the door to the drive recorder device 16. Specifically, the door opening/closing sensor 12 has the function of not only detecting the open/closed state of the door and transmitting the door opening/closing signal to the drive recorder device 16 when the ignition power supply 14 is turned on, but also detecting the open/closed state of the door and transmitting the door opening/closing signal to the drive recorder device 16 when the ignition power supply 14 is turned off (when the vehicle 1 is parked).

The acceleration sensor 13 detects acceleration indicating impact or the like applied to the vehicle 1 and transmits the detection result (acceleration signal) to the drive recorder device 16. Specifically, the acceleration sensor 13 has the function of not only detecting the acceleration and transmitting the acceleration signal to the drive recorder device 16 when the ignition power supply 14 is turned on, but also detecting the acceleration and transmitting the acceleration signal to the drive recorder device 16 when the ignition power supply 14 is turned off (when the vehicle 1 is parked).

The ignition power supply 14 provides power to devices (not shown) connected to the ignition power supply 14 when the ignition power supply 14 is turned on. When the ignition power supply 14 is turned off, the ignition power supply 14 transmits a signal indicating that the ignition power supply 14 is turned off to the drive recorder device 16.

The permanent power supply 15 supplies power to the drive recorder device 16 and the like.

In the example shown in FIG. 1, the drive recorder device 16 is constituted by a computer (for example, a drive recorder ECU (Electronic Control Unit) having communication interface (I/F) 161, memory 162, and processor 163.

The communication interface 161 is connected to, for example, the camera 11, the door opening/closing sensor 12, the acceleration sensor 13, the ignition power supply 14, and the like. The memory 162 stores (records) predetermined acceleration threshold value, predetermined time threshold value, video, signal and the like acquired by the acquisition unit 163A to be described later, program for realizing the function of the processor 163 and the like. The processor 163 has the function as an acquisition unit 163A, the function as a determination unit 163B, the function as a control unit 163C, and the function as a learning unit 163D.

The acquisition unit 163A acquires the video transmitted from the camera 11. Further, the acquisition unit 163A acquires the door opening/closing signal transmitted from the door opening/closing sensor 12. Furthermore, the acquisition unit 163A acquires the acceleration signal transmitted from the acceleration sensor 13. Further, the acquisition unit 163A acquires the signal indicating that the ignition power supply 14 is turned off transmitted from the ignition power supply 14.

The determination unit 163B determines whether the impact equal to or greater than the acceleration threshold value stored in the memory 162 is detected by the acceleration sensor 13. The determination unit 163B determines whether the door of the vehicle 1 changes from the open state to the closed state based on the door opening/closing signal acquired by the acquisition unit 163A. The determination unit 163B determines whether the video transmitted from the camera 11 is being recorded in the memory 162. The determination unit 163B determines whether the elapsed time since the start of the recording of the video in the memory 162 is equal to or greater than the time threshold value (for example, 60 seconds) stored in the memory 162. Furthermore, the determination unit 163B determines whether the ignition power supply 14 is turned off based on the signal transmitted from the ignition power supply 14.

The control unit 163C executes a processing of starting the recording of the video in the memory 162. Specifically, the control unit 163C starts recording the video to the memory 162 when the impact equal to or greater than the acceleration threshold value stored in the memory 162 is detected by the acceleration sensor 13 and when the ignition power supply 14 of the vehicle 1 is turned off.

The control unit 163C executes a processing of terminating the recording of the video in the memory 162. More specifically, the control unit 163C terminates the recording of the video in the memory 162 when the elapsed time since the start of the recording of the video in the memory 162 is equal to or greater than the time threshold value stored in the memory 162.

The learning unit 163D performs learning of the acceleration threshold value stored in the memory 162 by using the impact (acceleration) detected by the acceleration sensor 13. Specifically, when the door of the vehicle 1 changes from the open state to the closed state, the learning unit 163D learns the acceleration threshold value stored in the memory 162 using the impact detected by the acceleration sensor 13 during a learning period (that is, the learning period from the second time point to the first time point) between a first time point at which the door of the vehicle 1 changes from the open state to the closed state and a second time point which is a predetermined time (for example, 900 ms, or the like) before the first time point.

Specifically, the learning unit 163D performs the learning of the acceleration threshold value stored in the memory 162 by using the largest acceleration (impact) among the acceleration (impact) detected multiple times by the acceleration sensor 13 during the learning period from the second time point to the first time point. That is, the learning unit 163D stores the largest acceleration (impact) among the acceleration (impact) detected multiple times by the acceleration sensor 13 during the learning period from the second time point to the first time point in the memory 162 as the acceleration threshold value after learning.

In the example shown in FIG. 1, the detection of the acceleration (impact) by the acceleration sensor 13 is performed N times (N is an integer of 2 or more) during the learning period described above each time the ignition power supply 14 of the vehicle 1 is turned off. Further, each time the ignition power supply 14 of the vehicle 1 is turned off M times (M is an integer of 2 or more), the largest acceleration (impact) among (N×M) times acceleration (impact) detected by the acceleration sensor 13 is used, the learning of the acceleration threshold value is performed.

In another example, each time the ignition power supply 14 of the vehicle 1 is turned off, learning of the acceleration threshold value may be performed by using the largest acceleration (impact) among N times acceleration (impact) detected by the acceleration sensor 13.

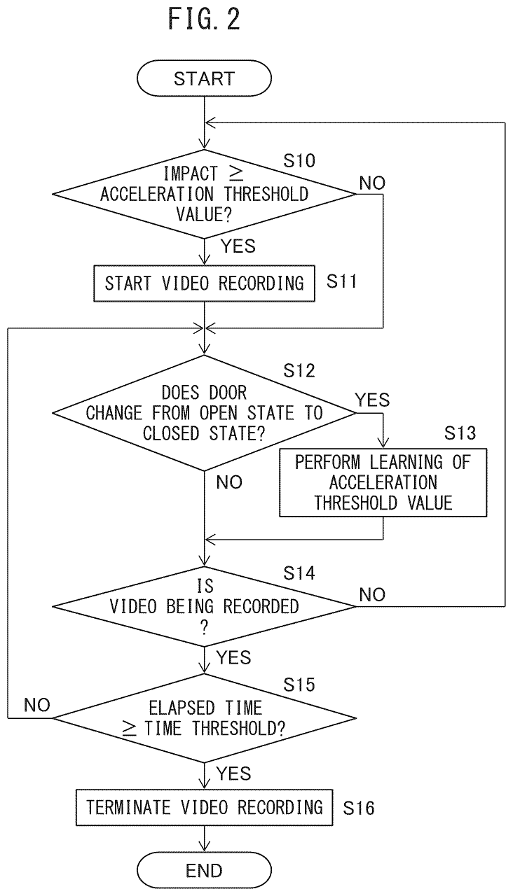

FIG. 2 is a flowchart for explaining an example of processing performed by the processor 163 of the drive recorder device 16 of the first embodiment. The processing shown in FIG. 2 is started when the acquisition unit 163A acquires the signal indicating that the ignition power supply 14 is turned off transmitted from the ignition power supply 14.

In the example shown in FIG. 2, at step S10, the acquisition unit 163A acquires the acceleration signal transmitted from the acceleration sensor 13. Further, the determination unit 163B determines whether the impact equal to or greater than the predetermined acceleration threshold value stored in the memory 162 at step not shown is detected by the acceleration sensor 13 based on the acceleration signal acquired by the acquisition unit 163A. When YES, it proceeds to step S11, while when NO, it proceeds to step S12.

At step S11, the acquisition unit 163A acquires the video transmitted from the camera 11. Further, the control unit 163C starts the processing of the recording the video acquired by the acquisition unit 163A in the memory 162.

At step S12, the acquisition unit 163A acquires the door opening/closing signal transmitted from the door opening/closing sensor 12. Further, the determination unit 163B determines whether the door of the vehicle 1 changes from the open state to the closed state based on the door opening/closing signal acquired by the acquisition unit 163A. When YES, it proceeds to step S13, while when NO, it proceeds to step S14.

At step S13, the learning unit 163D performs the learning of the acceleration threshold value stored in the memory 162 by using the acceleration signal acquired by the acquisition unit 163A. Specifically, the learning unit 163D performs the learning of the acceleration threshold value stored in the memory 162 using the impact detected by the acceleration sensor 13 (in detail, the acceleration signal acquired by the acquiring section 163A) during the learning period between the first time point at which it is determined that the door of the vehicle 1 changes from the open state to the closed state and the second time point which is the predetermined time (for example, 900 ms, or the like) before the first time point.

At step S14, the determination unit 163B determines whether the video transmitted from the camera 11 (in particular, the video acquired by the acquisition unit 163A) is being recorded in the memory 162. When YES, it proceeds to step S15, while when NO, it returns to step S10. If step S10 is executed after step S13 is executed, at step S10, the acceleration threshold value (learned acceleration threshold value) obtained by executing step S13 is used.

At step S15, the determination unit 163B determines whether the elapsed time since the start of the recording of the video in the memory 162 is equal to or greater than the predetermined time threshold (for example, 60 seconds) stored in the memory 162 at step not shown. When YES, it proceeds to step S16, while when NO, it returns to step S12.

At step S16, the control unit 163C terminates the processing of the recording of the video acquired by the acquisition unit 163A (the video transmitted from the camera 11) in the memory 162.

As described above, in the example in FIG. 1 and FIG. 2, the learning of the acceleration threshold value is performed by the learning unit 163D. Therefore, even when the predetermined acceleration threshold value is not suitable for the vehicle 1, the acceleration threshold value is changed to an appropriate value by the learning performed by the learning unit 163D. As a result, in the example shown in FIG. 1 and FIG. 2, even when the predetermined acceleration threshold value is not suitable for the vehicle 1, the video recording can be appropriately started by using the acceleration threshold value after the learning. In other words, it is possible to suppress a possibility that the video recording is unnecessarily started when the door of the vehicle 1 changes from the open state to the closed state.

In the example shown in FIG. 1 and FIG. 2, if an accident occurs during the learning period described above, for example, a warning encouraging the user of the vehicle 1 to repair the vehicle 1 is output, the processing shown in FIG. 2 is stopped. As a result, the detection result of the impact associated with the occurrence of the accident is not used for learning the acceleration threshold value, it is avoided that the acceleration threshold value after the learning becomes excessively large. Therefore, in the example shown in FIG. 1 and FIG. 2, if the accident occurs when the ignition power supply 14 is turned off after the learning of the acceleration threshold value is performed, the video recording can be appropriately started. In particular, even when the accident occurs simultaneously with a change from the open state to the closed state of the door of the vehicle 1 when the ignition power supply 14 is turned off after the learning of the acceleration threshold value is performed, the video recording can be appropriately started.

In the example shown in FIG. 1 and FIG. 2, when the vehicle 1 is used by a user who generates large impact (that is, the user who closes the door with a strong force) which is detected by the acceleration sensor 13 when the door of the vehicle 1 changes from the open state to the closed state, the acceleration threshold value after the learning performed by the learning unit 163D becomes larger than when the vehicle 1 is used by a user who generates small impact (that is, the user who closes the door quietly) which is detected by the acceleration sensor 13 when the door of the vehicle 1 changes from the open state to the closed state. Therefore, even when the vehicle 1 is used by the user who generates the large impact which is detected by the acceleration sensor 13 when the door of the vehicle 1 changes from the open state to the closed state, it is possible to suppress a possibility that video recording is unnecessarily started when the door of the vehicle 1 changes from the open state to the closed state (a possibility that it is erroneously determined that an accident occurred).

As described above, in the example shown in FIG. 1 and FIG. 2, the learning period is set between the first time point at which the door of the vehicle 1 changes from the open state to the closed state and the second time point which is the predetermined time (for example, 900 ms or the like) before the first time point. In other words, the control design considers the delay of the acceleration signal. Therefore, it is not necessary to place the drive recorder device 16 and the acceleration sensor 13 in proximity. That is, the acceleration sensor 13 can be shared by the drive recorder device 16 and another system (not shown), it is possible to suppress the overall cost of the vehicle 1.

### Second Embodiment

The vehicle 1 to which the drive recorder device 16 of a second embodiment is applied is configured similarly to the vehicle 1 to which the drive recorder device 16 of the first embodiment is applied shown in FIG. 1 except for the points to be described later.

As described above, in the example shown in FIG. 1, the learning unit 163D performs the learning of the acceleration threshold value stored in the memory 162 by using the largest acceleration (impact) among the acceleration (impact) detected multiple times by the acceleration sensor 13 during the learning period from the second time point to the first time point.

On the other hand, in an example of the drive recorder device 16 of the second embodiment, the learning unit 163D performs the learning of the acceleration threshold value stored in the memory 162 by using the standard deviation of the acceleration (impact) detected multiple times by the acceleration sensor 13 during the learning period from the second time point to the first time point. That is, the learning unit 163D stores the standard deviation of the acceleration (impact) detected multiple times by the acceleration sensor 13 during the learning period from the second time point to the first time point in the memory 162 as the acceleration threshold value after the learning.

That is, in the example of the drive recorder device 16 of the second embodiment, even if an accident occurs during the learning period from the second time point to the first time point, the standard deviation of the acceleration (impact) detected multiple times by the acceleration sensor 13 during the learning period from the second time point to the first time point is used for the learning of the acceleration threshold value, and the impact (>standard deviation) associated with the occurrence of the accident detected by the acceleration sensor 13 during the learning period from the second time point to the first time point is not used for the learning of the acceleration threshold value.

Consequently, in the example of the drive recorder device 16 of the second embodiment, the learning unit 163D performs the learning of the acceleration threshold value such that the acceleration threshold value becomes greater than the impact detected by the acceleration sensor 13 when the door changes from the open state to the closed state and the acceleration threshold value becomes less than or equal to the impact detected by the acceleration sensor 13 when the accident occurs.

That is, in the example of the drive recorder device 16 of the second embodiment, the acceleration threshold value after the learning becomes greater than the impact detected by the acceleration sensor 13 when the door changes from the open state to the closed state and becomes less than or equal to the impact detected by the acceleration sensor 13 when the accident occurs.

### Third Embodiment

The vehicle 1 to which the drive recorder device 16 of a third embodiment is applied is configured similarly to the vehicle 1 to which the drive recorder device 16 of the first embodiment is applied shown in FIG. 1 except for the points to be described later.

In an example of the drive recorder device 16 of the third embodiment, the learning unit 163D performs the learning of the acceleration threshold value stored in the memory 162 by applying machine learning (clustering, such as DBSCAN (Density-Based Spatial Clustering of Applications with Noise), for example) to the acceleration (impact) detected multiple times by the acceleration sensor 13 during the learning period from the second time point to the first time point. That is, the learning unit 163D stores the acceleration (impact) after the impact or the like associated with the occurrence of the accident is removed as noise among the acceleration (impact) detected multiple times by the acceleration sensor 13 during the learning period from the second time point to the first time point in the memory 162 as the acceleration threshold value after the learning.

That is, in the example of the drive recorder device 16 of the third embodiment, even if the accident occurs during the learning period from the second time point to the first time point, the impact associated with the occurrence of the accident is removed as the noise and is not used for the learning of the acceleration threshold value.

Consequently, in the example of the drive recorder device 16 of the third embodiment, the learning unit 163D performs the learning of the acceleration threshold value such that the acceleration threshold value becomes greater than the impact detected by the acceleration sensor 13 when the door changes from the open state to the closed state and the acceleration threshold value becomes less than or equal to the impact detected by the acceleration sensor 13 when the accident occurs.

That is, in the example of the drive recorder device 16 of the third embodiment, the acceleration threshold value after the learning becomes greater than the impact detected by the acceleration sensor 13 when the door changes from the open state to the closed state and becomes less than or equal to the impact detected by the acceleration sensor 13 when the accident occurs.

As described above, although the embodiments of the drive recorder device, the video recording method, and the non-transitory recording medium of the present disclosure has been described with reference to the drawings, the drive recorder device, the video recording method, and the non-transitory recording medium of the present disclosure are not limited to the embodiments described above, and appropriate changes can be made without departing from the scope of the present disclosure. The configuration of each example of the embodiment described above may be appropriately combined. In each example of the above-described embodiment, the processing performed in the drive recorder device 16 has been described as software processing performed by executing the program, but the processing performed in the drive recorder device 16 may be processing performed by hardware. Alternatively, the processing performed in the drive recorder device 16 may be a combination of both software and hardware. Further, the program (the program for realizing the function of the processor 163 of the drive recorder device 16) that is stored in the memory 162 of the drive recorder device 16 may be recorded in a computer-readable recording medium (a non-transitory recording medium) such as, for example, a semiconductor memory, a magnetic recording medium, an optical recording medium, or the like to be provided and distributed.

1. A drive recorder device comprising a processor configured to:
start video recording when an impact of a predetermined acceleration threshold value or more is detected by an acceleration sensor at the time of an ignition power supply of a vehicle being turned off;
determine whether a door of the vehicle changes from an open state to a closed state; and
learn the acceleration threshold value using the impact detected by the acceleration sensor during a learning period between a first time point at which the door changes from the open state to the closed state and a second time point which is a predetermined time before the first time point when the door changes from the open state to the closed state.

2. The drive recorder device according to claim 1, wherein
the processor is configured to learn the acceleration threshold value so that the acceleration threshold value is greater than the impact detected by the acceleration sensor when the door changes from the open state to the closed state, and less than or equal to the impact detected by the acceleration sensor when an accident occurs.

3. The drive recorder device according to claim 1, wherein
the processor is not configured to use the impact associated with occurrence of the accident among the impact detected by the acceleration sensor during the learning period to learn the acceleration threshold value.

4. A video recording method comprising:
starting video recording when an impact of a predetermined acceleration threshold value or more is detected by an acceleration sensor at the time of an ignition power supply of a vehicle being turned off;
determining whether a door of the vehicle changes from an open state to a closed state; and
learning the acceleration threshold value using the impact detected by the acceleration sensor during a learning period between a first time point at which the door changes from the open state to the closed state and a second time point which is a predetermined time before the first time point when the door changes from the open state to the closed state.

5. A non-transitory recording medium having recorded thereon a computer program for causing a processor to execute a processing comprising:
starting video recording when an impact of a predetermined acceleration threshold value or more is detected by an acceleration sensor at the time of an ignition power supply of a vehicle being turned off;
determining whether a door of the vehicle changes from an open state to a closed state; and
learning the acceleration threshold value using the impact detected by the acceleration sensor during a learning period between a first time point at which the door changes from the open state to the closed state and a second time point which is a predetermined time before the first time point when the door changes from the open state to the closed state.
